(19) United States
(12) Patent Application Publication
(10) Pub. No.: US 2012/0300463 A1
(43) Pub. Date: Nov. 29, 2012

(54) Miniaturized Laser Emitting Module

(75) Inventors: Hua-Tang Liu, Taichung City (TW); Ching-Shiang Wang, Taichung City (TW)

(73) Assignee: ASIA OPTICAL CO. INC., Taichung (TW)

(21) Appl. No.: 13/479,377

(22) Filed: May 24, 2012

(30) Foreign Application Priority Data
May 27, 2011 (TW) 100118663

(51) Int. Cl. F21V 5/04

(52) U.S. Cl. 362/259; 362/326

(57) ABSTRACT

A miniaturized laser emitting module includes a substrate, a laser diode and a lens element. The substrate includes an installation channel, the laser diode is installed in the installation channel of the substrate, and the lens element is installed in the installation channel of the substrate in a light-emitting direction of the laser diode. The lens element includes a collimating lens portion being adjacent to the laser diode and an undulating lens portion being distant from the laser diode. The collimating lens portion and the undulating lens portion are mutually connected to form as type of one piece.

### BACKGROUND OF THE INVENTION

1. Field of the Invention

The invention relates to an optical element, in particular relates to a miniaturized laser emitting module.

2. Description of the Related Art

Taiwan Patent No. M368224 discloses a laser emitting module, including a body, a laser diode, a collimator lens and an undulating lens, in which the laser diode is insertedly disposed on the body, and the collimator lens and the undulating lens are sequentially installed in the body along the laser diode. The collimator lens, capable of converting a single-point beam into a parallel beam, is utilized to determine degree of thicknesses or sizes of the outputting lights. The wave-shaped lens, capable of converting an incident beam into a straight line beam, is utilized to determine angles of the outputting lights.

In order to fully develop optical effects of the collimator lens and the wave-shaped lens in the U.S. Pat. No. '224 above, the positions and angles of the collimator lens and the wave-shaped lens must be carefully finely tuned and calibrated in the installation process, and relatively the working hour for installing the collimator lens and the wave-shaped lens is long. Moreover, with various components included, the size reduction to the whole structure of the laser emitting module in the U.S. Pat. No. '224 is limited, and therefore a competitive product with lightweight, thin and compact structure is almost impossible.

Accordingly, for the related manufactures, one of research and development targets is how to create a laser emitting module which is capable of reducing the installation working hour and providing a lightweight, thin and compact structure.

### BRIEF SUMMARY OF THE INVENTION

In view of this, the invention provides a miniaturized laser emitting module which is capable of reducing the installation working hour and reaching effects of lightness, thinness and compactness.

The miniaturized laser emitting module of the invention includes a substrate, a laser diode and a lens element. The substrate comprises an installation channel, the laser diode is installed in the installation channel of the substrate, and the lens element is installed in the installation channel of the substrate in a light-emitting direction of the laser diode. The lens element comprises a collimating lens portion being adjacent to the laser diode and an undulating lens portion being distant from the laser diode. The collimating lens portion and the undulating lens portion are mutually formed as type of one piece.

Further, a lens element of the invention comprises a collimating lens portion, an undulating lens portion, two side portions, two locating portions and two abutting surfaces. The collimating lens portion being adjacent to a laser diode comprises a light-entering surface and a relay light-exiting surface. The undulating lens portion being distant from the laser diode comprises a relay light-entering surface and a light-exiting surface. The collimating lens portion and the undulating lens portion are mutually connected to form as type of one piece. The side portions are connected to left and right ends of the collimating lens portion and the undulating lens portion. The collimating lens portion, the undulating lens portion and the side portions are mutually and integrally connected to form as a closed shape. The locating portions are respectively connected to the side portions, and the abutting surfaces are formed on the locating portions.

Further, a miniaturized laser emitting module of the invention comprises a lens element and a receiving element. The lens element comprises a collimating lens portion being adjacent to a laser diode and having a light-entering surface and an undulating lens portion being distant from the laser diode and having a light-exiting surface. The collimating lens portion and the undulating lens portion are integrally formed. The receiving element formed with side surfaces is provided for installing the lens element. The receiving element comprises a receiving seat installed with the lens element, a locating strip traversing the receiving seat, two locating portions respectively disposed on the side surfaces, and two abutting surfaces formed on the locating portions. The lens element is snugly fitted between the receiving seat and the locating strip.

The effect of the invention provides the collimating lens portion and the undulating lens portion to be mutually formed as type of one piece, thereby replacing conventional two-piece lens element and simplifying the calibration step and reducing the installation working hour, moreover, obtaining a lightweight, thin and compact laser emitting module via the simplified components of the lens element.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective exploded view of a first preferred embodiment of a miniaturized laser emitting module of the invention;

FIG. 2 is a perspective view of the first preferred embodiment of the invention, illustrating a configuration relationship of between a substrate, a laser diode and a lens element;

FIG. 3 is a perspective exploded view of a second preferred embodiment of a miniaturized laser emitting module of the invention; and

FIG. 4 is a perspective view of the second preferred embodiment of the invention, illustrating a configuration relationship of between a receiving element and a lens element.

### DETAILED DESCRIPTION OF THE INVENTION

Before describing the invention in detail, it is announced that similar elements are generally denoted by same reference number hereinafter.

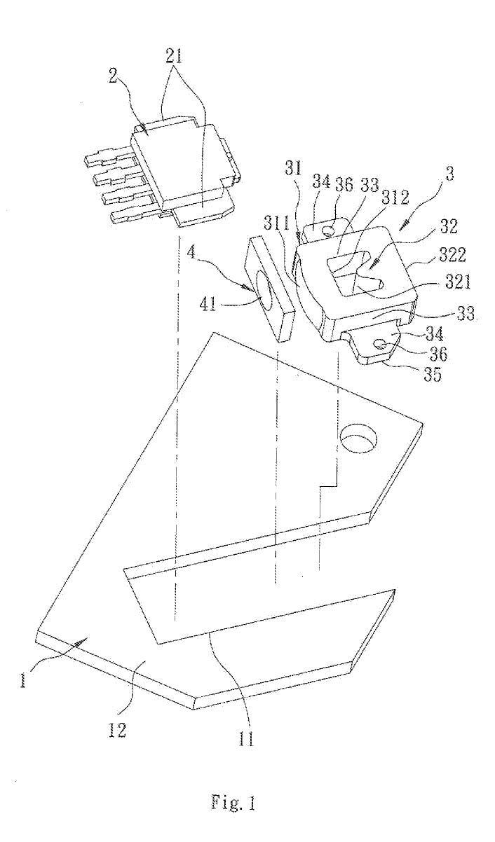

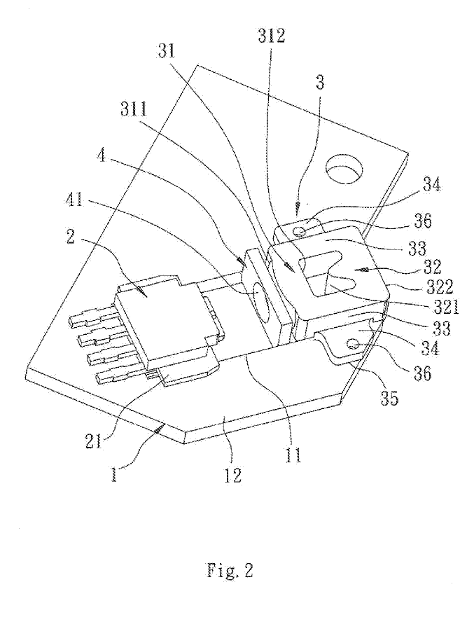

Referring to FIGS. 1 and 2, a first preferred embodiment of a miniaturized laser emitting module of the invention comprises a substrate 1, a laser diode 2, a lens element 3 and an aperture element 4.

The substrate 1 formed by shape of flat plate body comprises an installation channel 11 and a top surface 12.

The laser diode 2 is installed in the installation channel 11 of the substrate 1, comprising two heat-dissipation wing portions 21 which are abutted against the top surface 12 of the substrate 1.

The lens element 3 is installed in the installation channel 11 of the substrate 1 in a light-emitting direction of the laser diode 2, each of the substrate 1 and the laser diode 2 has a thickness less than that of the lens element 3, and the thickness of the lens element 3 can be reduced less than two millimeters. Thus, it is to be contributive to form a miniaturized laser emitting module with effects of lightness, thinness and compactness.

The lens element 3 comprises a collimating lens portion 31 being adjacent to the laser diode 2, an undulating lens portion 32 being distant from the laser diode 2, two side portions 33 connected to left and right ends of the collimating lens portion 31 and the undulating lens portion 32, two locating portions 34 respectively connected to the side portions 33, two abutting surfaces 35 formed on the locating portions 34 and abutted against the substrate 1, and two adhesive dripping holes 36 opened on the locating portions 34. The collimating lens portion 31 and the undulating lens portion 32 of the lens element 3 are mutually formed as type of one piece.

In the first preferred embodiment, to be more precisely, the collimating lens portion 31, the undulating lens portion 32 and the side portions 33 are mutually and integrally connected to form as a closed shape, and the collimating lens portion 31 and the undulating lens portion 32 are configured with a predetermined distance therebetween. With calibration and alignment to the collimating lens portion 31 and the undulating lens portion 32 performed in the manufacturing process, the working hours for installing the collimating lens portion 31 and the undulating lens portion 32 can be effectively reduced.

In the first preferred embodiment, the abutting surfaces 35 are formed on the bottom of the locating portions 34, and the locating portions 34 are abutted against the top surface 12 of the substrate 1. The top surface, the bottom surface, the left side surface and the right side surface of the lens element 3 are ink-smudged surfaces. That is, excluding the light-entering surface 311 and the relay light-exiting surface 312 of the collimating lens portion 31 and the relay light-entering surface 321 and the light-exiting surface 322 of the undulating lens portion 32, the lens element 3 are ink-smudged, to promote the optical quality thereof.

The aperture element 4, disposed between the lens element 3 and the laser diode 2, is opened with an aperture hole 41, thereby promoting the optical quality of the lens element 3.

According to the above-described disclosure, it can be appreciated that the configuration of the one-piece type lens element 3 connectively constructed by the collimating lens portion 31 and the undulating lens portion 32 can provide effects of simplifying the calibration steps and reducing the installation working hours, moreover, achieving effects of lightness, thinness and compactness.

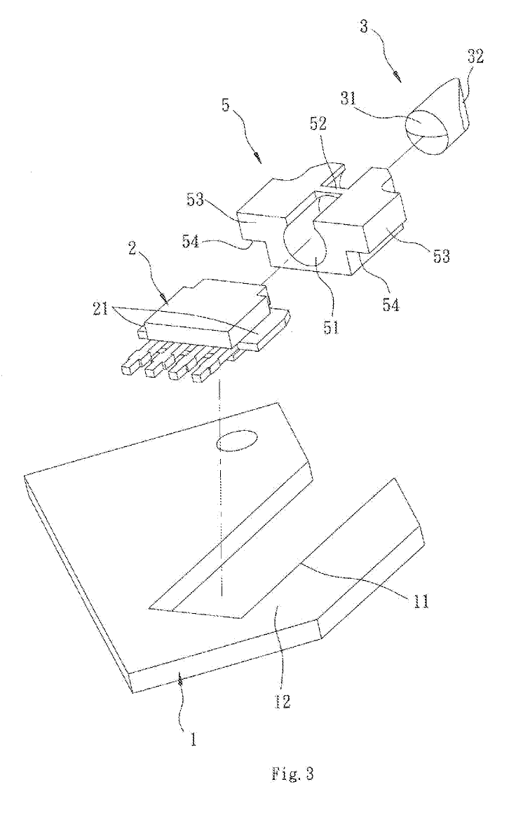

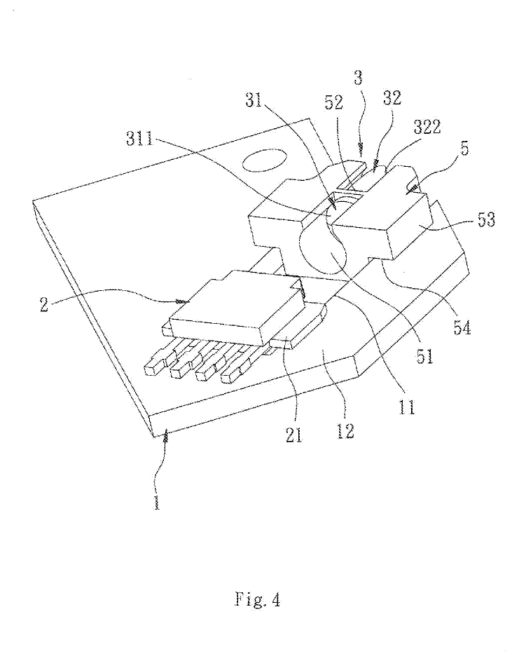

Referring to FIGS. 3 and 4, a second preferred embodiment of a miniaturized laser emitting module of the invention is provided. The components and assembly methods of the second preferred embodiment of the miniaturized laser emitting module are substantially the same as the second preferred embodiment. However, the second preferred embodiment differs from the first preferred embodiment in that the second preferred embodiment further comprises a receiving element 5 which is installed in the installation channel 11 of the substrate 1 and provided for installing the lens element 3.

The receiving element 5 comprises a receiving seat 51 installed with the lens element 3, a locating strip 52 traversing the receiving seat 51, two locating portions 53 respectively provided on both sides, and two abutting surfaces 54 formed on the locating portions 53 and abutted against the substrate 1, in which the abutting surfaces 54 are formed on the bottom of the locating portions 53, and the locating portions 53 are abutted against the top surface 12 of the substrate 1.

In the second preferred embodiment, the lens element 3 is substantially formed as a cylinder shape, the collimating lens portion 31 and the undulating lens portion 32 are integrally formed, the collimating lens portion 31 comprises a light-entering surface 311, the undulating lens portion 32 comprises a light-exiting surface 322, the receiving seat 51 of the receiving element 5 is substantially formed as a cylinder shape corresponding to the lens element 3, and the lens element 3 is snugly fitted between the receiving seat 51 and the locating strip 52 of the receiving element 5. According to the above-described disclosure, it can be appreciated that the configuration of the one-piece type lens element 3 connectively constructed by the collimating lens portion 31 and the undulating lens portion 32 can provide effects of simplifying the calibration steps and reducing the installation working hours.

In conclusion, with the collimating lens portion 31 and the undulating lens portion 32 to mutually form the one-piece type lens element 3 to be able to effectively simplify the calibration step and reduce the installation working hour, the lens element 3 can be rapidly and conveniently mounted on the substrate 1 via the locating portions 34 thereof (in the first preferred embodiment) and the locating portions 53 of the receiving element 5 (in the second preferred embodiment); moreover, with the structure of the lens element 3, the purpose of forming a lightweight, thin and compact miniaturized laser emitting module of the invention can be surely achieved.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A miniaturized laser emitting module, comprising:
a substrate, comprising an installation channel;
a laser diode installed in the installation channel of the substrate; and
a lens element installed in the installation channel of the substrate in a light-emitting direction of the laser diode, comprising a collimating lens portion being adjacent to the laser diode and an undulating lens portion being distant from the laser diode, wherein the collimating lens portion and the undulating lens portion are mutually connected to form as type of one piece.

2. The miniaturized laser emitting module as claimed in claim 1, wherein the lens element further comprises two side portions connected to left and right ends of the collimating lens portion and the undulating lens portion, two locating portions respectively connected to the side portions, and two abutting surfaces formed on the locating portions and abutted against the substrate, in which the collimating lens portion, the undulating lens portion and the side portions are mutually and integrally connected to form as a closed shape, the collimating lens portion comprises a light-entering surface and a relay light-exiting surface, and the undulating lens portion comprises a relay light-entering surface and a light-exiting surface.

3. The miniaturized laser emitting module as claimed in claim 2, wherein the lens element further comprises a top surface, a bottom surface, a left side surface and a right side surface, and the top surface, the bottom surface, the left side surface and the right side surface of the lens element are ink-smudged surfaces.

4. The miniaturized laser emitting module as claimed in claim 2 further comprising an aperture element disposed between the lens element and the laser diode.

5. The miniaturized laser emitting module as claimed in claim 1 further comprising a receiving element installed in the installation channel of the substrate and provided for installing the lens element, wherein the receiving element comprises lens element are integrally formed, the collimating lens portion of the lens element comprises a light-entering surface, and the undulating lens portion of the lens element comprises a light-exiting surface.

6. The miniaturized laser emitting module as claimed in claim 5, wherein the receiving element further comprises a locating strip traversing the receiving seat, and the lens element is snugly fitted between the receiving seat and the locating strip of the receiving element.

7. The miniaturized laser emitting module as claimed in claim 5, wherein the receiving element further comprises two locating portions respectively disposed on side surfaces thereof and two abutting surfaces formed on the locating portions and abutted against the substrate.

8. The miniaturized laser emitting module as claimed in claim 1 wherein each of the substrate and the laser diode has a thickness less than that of the lens element, and the thickness of the lens element is less than two millimeters.

9. A lens element, comprising:
a collimating lens portion being adjacent to a laser diode, comprising a light-entering surface and a relay light-exiting surface;
an undulating lens portion being distant from the laser diode, comprising a relay light-entering surface and a light-exiting surface and connected to the collimating lens portion mutually to form as type of one piece;
two side portions, connected to left and right ends of the collimating lens portion and the undulating lens portion and connected to the collimating lens portion and the undulating lens portion mutually and integrally to form as a closed shape;
two locating portions, respectively connected to the side portions; and
two abutting surfaces formed on the locating portions.

10. A miniaturized laser emitting module, comprising:
a lens element, comprising a collimating lens portion being adjacent to a laser diode and having a light-entering surface and an undulating lens portion being distant from the laser diode and having a light-exiting surface, in which the collimating lens
a receiving element provided for installing the lens element, comprising a receiving seat installed with the lens element, a locating strip traversing the receiving seat, two locating portions respectively disposed on both sides of the lens element and two abutting surfaces formed on the locating portions, and the lens element is snugly fitted between the receiving seat and the locating strip.
